(19) United States
(12) Patent Application Publication
(10) Pub. No.: US 2016/0339974 A1
(43) Pub. Date: Nov. 24, 2016

(54) CHAIN ASSEMBLY HAVING A RETENTION FEATURE

(71) Applicant: Caterpillar Inc., Peoria, IL (US)

(72) Inventors: Jennifer Ann Brooks, Germantown Hills, IL (US); Roger Lee Recker, Dunlap, IL (US)

(73) Assignee: Caterpillar Inc., Peoria, IL (US)

(21) Appl. No.: 14/718,708

(22) Filed: May 21, 2015

(51) Int. Cl. B62D 55/088; B62D 55/092; B62D 55/21

(52) U.S. Cl. CPC B62D 55/088; B62D 55/21; B62D 55/092

(57) ABSTRACT

A chain assembly having a retention feature is disclosed. The chain assembly may be used in conjunction with a mobile machine and may include a pair of track links and a track link connector. The track link connector may have an elongate, substantially cylindrical body having a length dimension and having a substantially annular exterior surface and first and second opposing end portions. The first end portion may be inserted into a bore of one of the track links and form an interface therebetween. The interface may have an axial length. The track link connector may further have a retention feature extending 360 degrees around a circumference of the exterior surface of the body at the interface. The retention feature may be a roughened surface and may cover a first portion of the interface closest to a center of the cylindrical body.

### TECHNICAL FIELD

The present disclosure relates generally to a chain assembly and, more particularly, to a chain assembly having a retention feature.

### BACKGROUND

A mobile machine may be used to perform various types of work on different worksites, such as a construction site, a demolition site, a mining site, or a landfill site. For example, a bulldozer may be used to push soil and rock on a construction site. Some of these mobile machines are track-type machines that include a tracked undercarriage with tracks on the left and right sides of the machine. Each of the tracks includes a chain formed by sequentially connecting pairs of track links to one another using a track link connector. For example, a pin may be inserted through a pair of aligned bores in adjacent track links and secured in place (e.g., via press-fitting) to attach the track links to each other.

During operation, the track link connectors may gradually move axially within the track link bores, potentially weakening the chain assembly. In order to help prevent such movement, the track link connectors may include a retention feature, such as a roughened surface at the location where the track link connector contacts a corresponding track link. The roughened surface increases a retention force at the track link joints, thereby resisting axial movement of the track link connector relative to the track link.

An example of a track link connector that includes a roughened surface is disclosed in U.S. Patent Application Publication No. 2013/0000995 by Dumitru et al., published on Jan. 3, 2013 (“the ′995 publication”). The track link connector of the ′995 publication includes a pin with several circumferentially spaced textured regions. The textured regions extend an entire width of an interface between the pin and a track link. The textured regions resist movement of the pin out of a corresponding track link bore.

There may be potential drawbacks to using a roughened surface as a retention feature, however. For example, in tractor undercarriage applications, where lubricant sealing at a track link joint is a priority, a roughened track link connector surface may create a leakage path for lubricant. These issues are balanced with the need for a retention feature that provides a retention force sufficient to secure the track links in place over long periods of time and repeated use.

The present disclosure is directed at overcoming one or more of the shortcomings set forth above and/or other problems of the prior art.

### SUMMARY OF THE DISCLOSURE

In one aspect, the present disclosure is directed to a chain assembly for a mobile machine. The chain assembly may include a first track link including a first bore at an inner track link portion, a second track link including a second bore at an outer track link portion, and a track link connector. The track link connector may include an elongate, substantially cylindrical body having a length dimension and including a substantially annular exterior surface and first and second opposing end portions. The first end portion may be inserted into the first and second bores and form an interface between the first end portion and the second bore. The interface may include an axial length. The track link connector may further include a retention feature extending 360 degrees around a circumference of the exterior surface of the body at the interface, the retention feature being a roughened surface. The retention feature may be located only at a first portion of the interface that makes up approximately 5-80% of the axial length of the interface. The interface may include a second portion that makes up approximately 20-95% of the axial length of the interface. Further, the first portion may be closer than the second portion to a center of the cylindrical body.

In another aspect, the present disclosure is directed to another chain assembly for a mobile machine. The chain assembly may include a first track link including a first bore at an inner track link portion, a second track link including a second bore at an outer track link portion, and a track link connector. The track link connector may include an elongate, substantially cylindrical body having a length dimension and including a substantially annular exterior surface and first and second opposing end portions. The first end portion may be inserted into the first and second bores and form an interface between the first end portion and the second bore. The interface may include an axial length. The track link connector may further include a retention feature extending 360 degrees around a circumference of the exterior surface of the body at the interface. The track link connector may also include a sealing feature extending 360 degrees around a circumference of the exterior surface of the body at the interface. The retention feature may cover a first portion of the interface and the sealing feature may cover a second portion of the interface. The first portion may be closer than the second portion to a center of the cylindrical body and the cylindrical body may include a constant diameter that covers the first portion and the second portion.

In yet another aspect, the present disclosure is directed to a track link connector. The track link connector may include an elongate, substantially cylindrical body having a length dimension and including a substantially annular exterior surface and first and second opposing end portions, and a fluid reservoir formed in the cylindrical body. The track link connector may also include a retention feature extending 360 degrees around a circumference of the exterior surface of the body, the retention feature being a roughened surface, and a sealing feature extending 360 degrees around a circumference of the exterior surface of the body at the interface, the sealing feature being a smooth surface. The retention feature may be closer than the sealing feature to a center of the cylindrical body and the cylindrical body may include a constant diameter that covers the first portion and the second portion.

### BRIEF DESCRIPTION OF THE DRAWINGS

FIG. 1 illustrates a mobile machine having a track assembly;

FIG. 2 illustrates a portion of an exemplary chain assembly of the track assembly of FIG. 1;

FIG. 3 illustrates a cross-sectional view of the chain assembly of FIG. 2; and

FIG. 4 illustrates an exemplary track link connector of the chain assembly of FIGS. 2-3.

### DETAILED DESCRIPTION

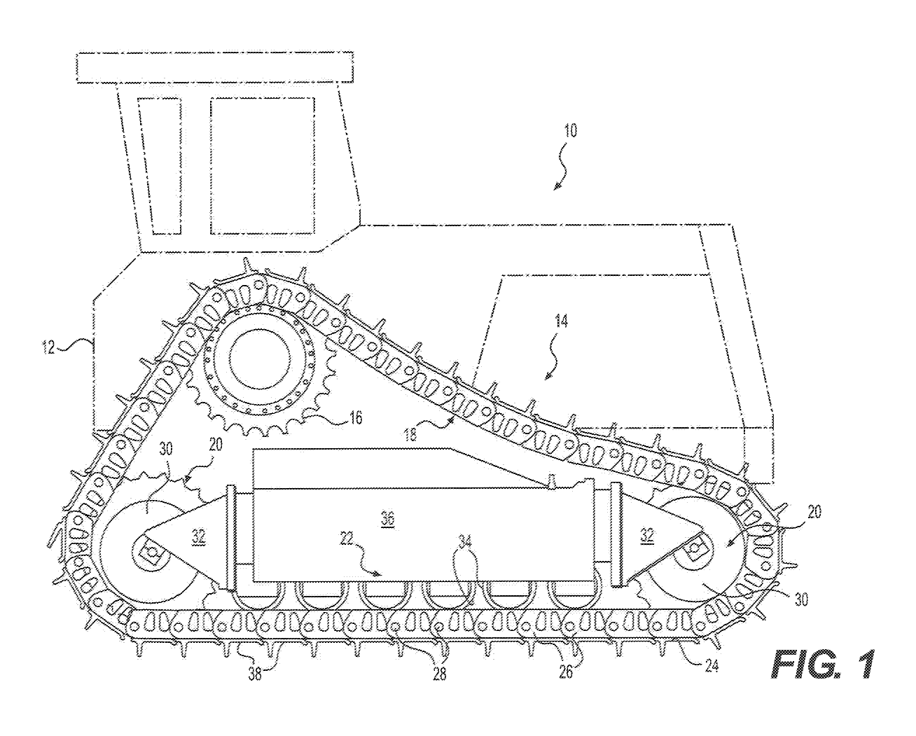

FIG. 1 illustrates an exemplary track-type machine 10, consistent with disclosed embodiments. Track-type machine 10 may embody any machine that is driven, propelled, positioned, and/or maneuvered by operating a “continuous” track-type traction device. Such machines may include, for example, track-type tractors, skid steers, dozers, excavators, backhoes, track loaders, front shovels, rope shovels, or any other type of track-maneuverable machine. Machine 10 may include a frame 12 and a pair of track assemblies 14 (only one shown) secured to frame 12 on opposing sides of machine 10. Track assembly 14 may include a drive sprocket 16 coupled to a driving mechanism (not shown), and a chain assembly 18 operatively coupled to the driving mechanism by drive sprocket 16 and configured to propel machine 10.

The driving mechanism may include one or more components configured to generate a torque output. For example, the driving mechanism may include any suitable type of internal combustion engine, such as a gasoline, diesel, natural gas, or hybrid-powered engine or turbine. Alternatively or additionally, the driving mechanism may embody an electric motor, electrically coupled to an electric power source and configured to convert at least a portion of the electrical energy from the electric power output into mechanical energy. According to yet another embodiment, the driving mechanism may include a hydraulic motor fluidly coupled to a hydraulic pump and configured to convert a fluid pressurized by the pump into a torque output.

Drive sprocket 16 may be coupled to the driving mechanism via a shaft, which may provide an interface for delivering torque generated by the driving mechanism to drive sprocket 16. For example, drive sprocket 16 may be secured (e.g., welded, bolted, heat-coupled, etc.) to a hub associated with a shaft, so that drive sprocket 16 rotates in response to the torque generated by the driving mechanism. In some embodiments, drive sprocket 16 may be directly coupled via a drive shaft to the driving mechanism. Alternatively, drive sprocket 16 may be coupled to the driving mechanism via a torque converter (such as a gearbox, transmission, etc.), so that rotation of drive sprocket 16 is proportional to the torque generated by the driving mechanism.

Track assembly 14 may include a plurality of components that form the “continuous” track, ground-engaging portion of the drive system of machine 10. Track assembly 14 may include, among other things, drive sprocket 16, chain assembly 18, at least one idler assembly 20, a roller assembly 22, and a traction assembly 24. However, it should be understood that these components of track assembly 14 are exemplary only and not intended to be limiting. Accordingly, track assembly 14 may include additional and/or different components than those listed above.

Chain assembly 18 may form a continuous chain connected around outer portions of drive sprocket 16, idler assemblies 20, and roller assembly 22. As used herein, a “chain assembly” may be a completed chain of track links 26 and track link connectors 28 or a chain module that includes at least one track link 26 and at least one track link connector 28 and is configured to be secured to other modules or components to complete the chain. Traction assembly 24 may be connected to an outer portion of chain assembly 18 and configured to engage a ground surface beneath track-type machine 10. In use, rotation of drive sprocket 16 may cause chain assembly 18 to move around drive sprocket 16, idler assemblies 20, and roller assembly 22, causing traction assembly 24 to engage the ground and thereby propel track-type machine 10 in a manner known in the art.

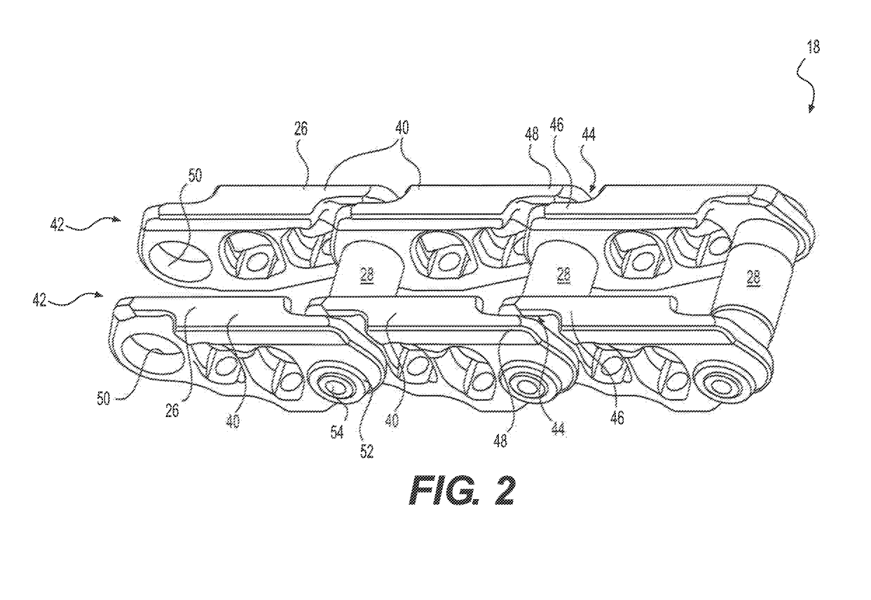

In an exemplary embodiment, chain assembly 18 may include a plurality of interconnected track links 26. It should be understood that “track link,” as used herein, refers to any linkage component of a continuous chain for a track-type machine, and is not limited to track links 26 described herein. In one embodiment, adjacent (e.g., consecutive) track links 26 may be coupled together via a plurality of track link connectors 28. Track link connectors 28 may include a track pin assembly, which includes a track pin and may optionally include seals, bearings, bushings, and/or other structures. In an exemplary embodiment, chain assembly 18 may include two parallel sets of track links, connected to each other by track link connectors 28 (shown in FIG. 2).

Idler assemblies 20 may include components configured to guide chain assembly 18 as it moves around track assembly 14. For example, each idler assembly 20 may include an idler 30 and a mount 32. Idlers 30 may include features configured to engage chain assembly 18. For example, idlers 30 may include engagement surfaces configured to contact and guide track links 26 as they pass around idler 30. In some embodiments (such as idler 30 shown in FIG. 1), idler 30 may include idler teeth (e.g., between the engagement surfaces) configured to engage track link connectors 28. In other embodiments, the engagement surfaces may be separated by a flange. Each mount 32 may secure idler 30 in place on machine 10 through connection to frame 12.

Roller assembly 22 may also include components configured to guide chain assembly 18. For example, roller assembly 22 may include a plurality of rollers 34 and a roller frame 36. Roller frame 36 may be mounted to frame 12 of machine 10. Rollers 34 may guide chain assembly 18 at a lower side of roller frame 36. Rollers 34 may each be suspended from roller frame 36. For example, each of rollers 34 may be rotationally supported on an axle suspended below roller frame 36. Rollers 34 may ride on and guide track links 26 as they pass under roller frame 36.

Traction assembly 24 may include a plurality of track shoes 38 carried by chain assembly 18. In some embodiment, track shoes 38 may be separate from chain assembly 18 and include a connecting portion configured to be secured to one or more track links 26 and a ground engaging portion configured to contact the ground. In other embodiments, individual track shoes 38 and track links 26 may be integrally formed as one piece. The ground engaging portion may include one or more features (e.g., grouser bars) that provide increased traction between track shoes 38 and the ground. It should be understood, however, that the disclosed embodiments may be used with any type of track shoe forming a part of a track assembly used by a track-type mobile machine. In other embodiments, track shoes 38 may be omitted entirely from track assembly 14, so that surfaces of track links 26 that would otherwise contact track shoes 38 may contact the ground surface under machine 10.

FIG. 2 further illustrates a portion of chain assembly 18. Chain assembly 18 may include a plurality of track links 26 interconnected by track link connectors 28. Each track link 26 may include an engagement surface 40. Track links 26 are arranged such that aligned engagement surfaces 40 form parallel tracks 42 separated by track link connectors 28. The parallel tracks 42 formed by engagement surfaces 40 may contact corresponding engagement surfaces of drive sprocket 16, idler assemblies 20, and roller assembly 22 as each associated track link 26 moves around track assembly 14.

In order to form the continuous parallel tracks 42, each track link 26 may be configured to sequentially connect to an adjacent other track link 26 at a track link joint 44. At each track link joint 44, a track link connector 28 may connect an inner track link portion 46 of a first track link 26 to an outer track link portion 48 of a second track link 26. As shown in FIG. 2, each track link 26 may be configured such that a first end of the track link 26 includes an inner track link portion 46 and a second end of the same track link 26 includes an outer track link portion 48. In this way, similarly shaped track links 26 may be sequentially connected to each other to form the parallel tracks 42. It should be understood, however, that other configurations are possible. For example, track links 26 may be configured such that some track links 26 include only inner track link portions 46 at both ends and other track links 26 include only outer track link portions 48 at both ends.

In an exemplary embodiment, each track link 26 may include a pair of bores 50, 52. For example, each track link 26 may include a bore 50 at the inner track link portion 46 and a bore 52 at the outer track link portion 48 thereof. In order to secure a first track link 26 to a second track link 26, bore 50 at the inner track link portion 46 of the first track link 26 may be aligned with bore 52 at the outer track link portion 48 of the second track link 26. Track link connector 28 (e.g., a pin) may be inserted through aligned bores 50, 52 and secured in place to attach the track links 26 together. For example, track link connector 28 may be press fit within at least bore 52 such that a fixed connection is created. This process may be repeated on an opposite side of track link connector 28 with two other track links 26 and at opposite ends of the track links 26 to create the continuous, parallel tracks 42 of chain assembly 18.

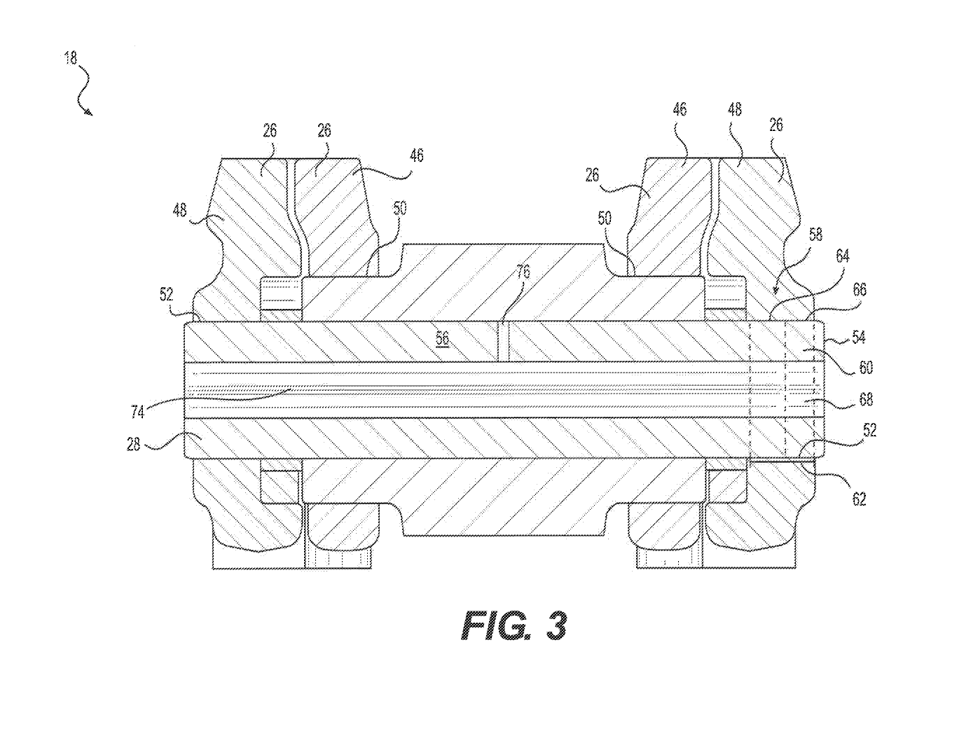

FIG. 3 depicts a cross-sectional view of chain assembly 18 including a track link connector 28 that connects two pairs of track links 26 at corresponding track link joints 44. Each track link joint 44 includes a first track link 26 with an inner track link portion 46 secured to an outer track link portion 48 of a second track link 26. At each track link joint 44 a first end portion 54 of track link connector 28 may be fit (e.g., via press fitting or otherwise creating an interference fit, etc.) into bore 52 of a track link 26 such that track link connector 28 is fixedly attached thereto at an interface 58. An inward portion 56 of track link connector 28 may extend through bore 50 and be secured thereto to connect the pair of track links 26 to each other (e.g., inner track link portion 46 to outer track link portion 48). For example, a bushing may surround inward portion 56 (and secured thereto) and be inserted into bore 50. It should be understood, however, that other mechanisms for securing inner track link portions 46 may be used (e.g., fitting bore 50 directly to track link connector 28 or via bearings, seals, etc.).

In some embodiments, track link connector 28 may include a fluid reservoir 74. For example, fluid reservoir 74 may be formed by a hollow interior of track link connector 28 which is configured to retain a fluid. Fluid reservoir 74 may be enclosed (e.g., open ends of track link connector 28 plugged) except for one or more channels 76 that lead to an exterior of track link connector 28. Channel 76 may provide an outlet for fluid (e.g., lubricant, oil, etc.) held in fluid reservoir 74 to reach an exterior surface of track link connector 28 and thereby lubricate track link joint 44. For example, fluid may travel through channel 76 to an area between track link connector 28 and a bushing, thereby providing a lubricated interface that helps to inhibit wear. In some embodiments of track assembly 14, fluid reservoir 74 may serve as a sole source of lubricant for an associated track link joint 44. Therefore, preventing leakage of the lubricant and allowing the fluid to be slowly metered through channel 76 may be a priority for track assemblies 14 that implement track link connectors that are configured in this way.

Track link connector 28 may include a retention feature 60 at interface 58. Retention feature 60 may be configured to help retain track link connector 28 within bore 52. In an exemplary embodiment, retention feature 60 may be a roughened surface on an exterior of track link connector 28. As used herein a “roughened surface” includes a surface that includes a surface roughness that is greater than a surface roughness of an otherwise substantially smooth surface. For example, retention feature 60 may be a knurled surface. However, it should be understood that a roughened surface could be formed in other ways, and that the roughened surface is not necessarily formed through a “roughening” process. For example, a component that includes a roughened surface may be manufactured in a manner that results in a roughened surface, regardless of whether a corresponding surface thereof is treated in any way.

Retention feature 60 may increase a retention force between track link connector 28 and track link 26 such that it causes track link connector 28 to resist axial movement with respect to the connected track link 26. Further, a symmetrical configuration of retention feature 60 may allow retention feature 60 to resist axial movement in two directions (e.g., both axial directions) approximately equally. For example, the roughened surface may create multiple points of contact between track link connector 28 and an inside of bore 52 such that track link connector 28 digs into the inside surface of track link 26, thereby increasing the coefficient of static friction that resists axial movement of track link connector 28.

Interface 58 may include an axial length 62. For example, axial length 62 may be equal to an axial length of bore 52. In an exemplary embodiment, retention feature 60 may cover (e.g., extend only at) a portion of axial length 62 of interface 58. For example, retention feature 60 may cover a first portion 64 of interface 58, while track link connector 28 may include another feature that covers a second portion 66 of interface 58.

In some embodiments, track link connector 28 may include a sealing feature 68 that covers (e.g., extends only at) a second portion 66 of interface 58. In some embodiments, retention feature 60, being a roughened surface, may create a leak path for fluid to flow toward second portion 66. Sealing feature 68 may be configured to seal fluid that travels in the leak path, in order to prevent leakage of fluid out of track joint 44. For example, sealing feature 68 may be configured to inhibit fluid held in fluid reservoir 74 from leaking from track link joint 44 via a path through interface 58. In some embodiments, sealing feature 68 may be a smooth surface of track link connector 28. The smooth surface, when press fit to bore 52, helps to prevent any leak paths created by retention feature 60 from continuing toward end portion 54 and out of bore 52.

In an exemplary embodiment, first portion 64 may make up approximately 5-80% of axial length 62 of interface 58, and second portion 66 may make up approximately 20-95% of axial length 62 of interface 58 (e.g., a remainder of axial length 62 that is not first portion 64). In another example, first portion 64 may make up approximately 25-50% of axial length 62 of interface 58 and second portion may make up 50-75% of axial length 62 of interface 58. These exemplary dimensions have been found to provide a sufficient retention force to interface 58, while allowing sufficient space for track link connector 28 to create a seal to inhibit fluid from leaking.

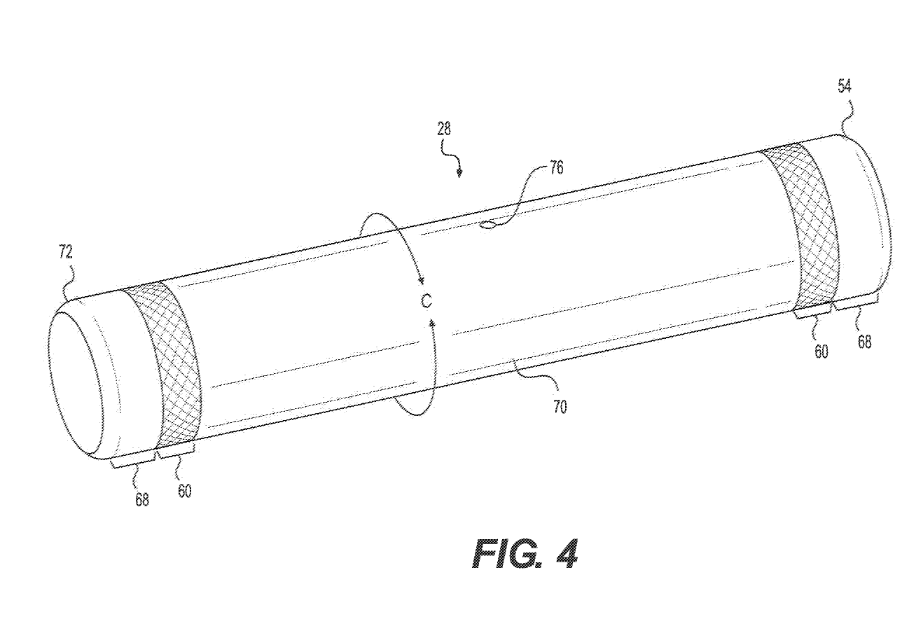

FIG. 4 depicts an exemplary track link connector 28. While track link connector 28 is shown as a track pin, it should be understood that track link connector 28 may be a track pin assembly that includes additional components and/or features, such as bearings, bushings, etc. Track link connector 28 may include an elongate, substantially cylindrical body 70 having a length dimension and including a substantially annular exterior surface extending between first end portion 54 and an opposing second end portion 72. Each end portion 54, 72 may include retention feature 60 and sealing feature 68.

Retention feature 60 may extend inward of sealing feature 68 such that, when an end portion 54, 72 is fit into a bore 52, sealing feature 68 is outward of retention feature 60 to help prevent fluid leakage. In other words, retention feature 60 may be closer that sealing feature 68 to a center of cylindrical body 70 (e.g., a center point of an axial length of cylindrical body 70). It should be understood, however, that the positions of retention feature 60 and sealing feature 68 may be modified in alternative embodiments. For example, sealing feature 68 may be located inward of retention feature 60. Further, in some embodiments, retention feature 60 may be located on an interior surface of bore 52 in addition or alternative to retention feature 60 on track link connector 28. For example, retention feature 60 may include a roughened surface on an interior surface of track link 26 surrounding bore 52. The retention feature 60 (e.g., the roughened surface) may extend 360 degrees around interface 58 by being located on an exterior surface of cylindrical body 70, an interior surface surrounding bore 52, or a combination thereof.

The dimensions of retention feature 60 and sealing feature 68 may be configured to correspond to the exemplary dimensions of the first and second portions 64, 66 of interface 58. For example, of a combined width of retention feature 60 and sealing feature 68, retention feature 60 may make up approximately 5-80% (or, more particularly, 25-50%) thereof, while sealing feature 68 makes up 20-95% thereof (e.g., the remainder). Moreover, cylindrical body 70 may include a constant diameter that covers retention feature 60 and sealing feature 68.

Further, in an exemplary embodiment, retention feature 60 may extend 360 degrees around a circumference C of the exterior surface of body 70. Sealing feature 68 may also extend 360 degrees around the circumference C. As discussed herein, these dimensions have been found to balance increased retention force with sufficient sealing properties for track link joint 44.

### INDUSTRIAL APPLICABILITY

The disclosed track link connector allows for improved retention of a track link joint without sacrificing sealing properties that keep fluid from leaking out of the track link joint. The disclosed configurations may be particularly applicable to certain tractor undercarriages where sealing of lubricant is a priority, but interfaces of track link joints are relatively short (and thus may be susceptible to axial movement of the track link connecter). For example, in instances where a track link connector may include only a limited supply of lubricant (e.g., an amount of fluid held in a fluid reservoir therein), the disclosed track link connector is particularly suited to inhibit leakage of that fluid while also providing desired retention properties.

Retention feature 60 may be added to a track link connector 28 through a roughening process, such as knurling at the corresponding area. Sealing feature 68 may be formed by polishing or otherwise ensuring a smooth exterior surface of track link connector 28 at a corresponding area. During assembly of chain assembly 18, a track link connector 28 may be installed by press fitting (or otherwise interference fitting) an end portion (e.g., 54 or 72) thereof into a bore 52. Retention feature 60, being a roughened surface, allows track link connector 28 to be press fit to bore 52 from either of two directions (e.g., through either opening into bore 52). The roughened surface may dig into the interior surface of track link 26 at bore 52, thereby increasing a coefficient of static friction and increasing a retention strength at track link joint 44.

Extending the retention feature 360 degrees around a circumference of a track link connector, but not an entire axial length of the interface, creates an efficient balance between retention properties and sealing properties for the disclosed track link connector and corresponding track link joints of a chain assembly. Further, the roughened surface, being generally symmetrical, helps to inhibit axial movement of the track link connector in two directions approximately equally. In addition, utilizing a track link connector that includes a constant diameter between two different portions (e.g., retention feature and sealing feature) allows the track link connector to be inserted into a bore with a constant diameter without irreversibly deforming the track link connector or bore. This may allow the track link connector and/or the associated track link to be reused and/or more easily remanufactured. The disclosed features in combination allow for the manufacturing of a strong, durable chain assembly for a mobile machine that experiences heavy use.

It will be apparent to those skilled in the art that various modifications and variations can be made to the disclosed chain assembly having a retention feature. Other embodiments will be apparent to those skilled in the art from consideration of the specification and practice of the disclosed chain assembly having a retention feature. It is intended that the specification and examples be considered as exemplary only, with a true scope being indicated by the following claims and their equivalents.

What is claimed is:

1. A chain assembly for a track-type machine, comprising:
a first track link including a first bore at an inner track link portion;
a second track link including a second bore at an outer track link portion;
a track link connector including an elongate, substantially cylindrical body having a length dimension and including a substantially annular exterior surface and first and second opposing end portions, the first end portion being inserted into the first and second bores and forming an interface between the first end portion and the second bore, the interface between the first end portion and the second bore having an axial length; and
a retention feature extending 360 degrees around a circumference of the exterior surface of the body at the interface, the retention feature being a roughened surface,
wherein the retention feature is located only at a first portion of the interface that makes up approximately 5-80% of the axial length of the interface,
wherein the interface includes a second portion that makes up approximately 20-95% of the axial length of the interface, and
wherein the first portion is closer than the second portion to a center of the cylindrical body.

2. The chain assembly of claim 1, wherein the retention feature is a knurled surface.

3. The chain assembly of claim 1, further including a sealing feature that is located only at the second portion of the interface.

4. The chain assembly of claim 3, wherein the sealing feature is a smooth surface.

5. The chain assembly of claim 1, wherein the retention feature is configured to generate a retention force at the interface to cause the track link connector to resist axial movement with respect to the second track link.

6. The chain assembly of claim 5, wherein the retention feature is configured to cause the track link connector to resist axial movement with respect to the second track link approximately equally in two directions.

7. The chain assembly of claim 1, wherein the track link connector is press fit to the second bore.

8. The chain assembly of claim 7, wherein the track link connector is configured to be press fit to the second bore from either of two directions.

9. The chain assembly of claim 1, wherein the track link connector further includes a fluid reservoir formed therein.

10. The chain assembly of claim 9, further including a sealing feature that is located only at the second portion of the interface and is configured to inhibit fluid from the fluid reservoir from leaking through the interface.

11. The chain assembly of claim 10, wherein the sealing feature is a smooth surface.

12. The chain assembly of claim 1, wherein the first portion of the interface makes up approximately 25-50% of the axial length.

13. A chain assembly for a mobile machine, comprising:
a first track link including a first bore at an inner track link portion;
a second track link including a second bore at an outer track link portion;
a track link connector including an elongate, substantially cylindrical body having a length dimension and including a substantially annular exterior surface and first and second opposing end portions, the first end portion being inserted into the first and second bores and forming a generally annular interface between the first end portion and the second bore, the interface between the first end portion and the second bore having an axial length;
a retention feature extending 360 degrees around the interface; and
a sealing feature extending 360 degrees around the interface;
wherein the retention feature covers a first portion of the axial length of the interface,
wherein the sealing feature covers a second portion of the axial length of the interface, and
wherein the cylindrical body includes a constant diameter that covers the first portion and the second portion.

14. The chain assembly of claim 13, wherein the retention feature is a roughened surface.

15. The chain assembly of claim 14, wherein the sealing feature is a smooth surface.

16. The chain assembly of claim 13, wherein the track link connector is press fit to the second bore.

17. The chain assembly of claim 16, wherein the track link connector is configured to be press fit to the second bore from either of two directions.

18. The chain assembly of claim 13, wherein the track link connector further includes a fluid reservoir formed therein.

19. The chain assembly of claim 18, wherein the sealing feature is configured to inhibit fluid from the fluid reservoir from leaking through the interface.

20. A track link connector, comprising:
an elongate, substantially cylindrical body having a length dimension and including a substantially annular exterior surface and first and second opposing end portions;
a fluid reservoir formed in the cylindrical body;
a retention feature extending 360 degrees around a circumference of the exterior surface of the body, the retention feature being a roughened surface; and
a sealing feature extending 360 degrees around a circumference of the exterior surface of the body at the interface, the sealing feature being a smooth surface,
wherein the retention feature is closer than the sealing feature to a center of the cylindrical body, and
wherein the cylindrical body includes a constant diameter that covers the retention feature and the sealing feature.
